(19) United States
(12) Patent Application Publication
(10) Pub. No.: US 2007/0115650 A1
(43) Pub. Date: May 24, 2007

(54) Illuminated exhibitor

(76) Inventors: Howard Cohan, Fort Lauderdale, FL (US); Chrissa Paloni, Fort Lauderdale, FL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/203,565

(22) Filed: Aug. 12, 2005

(51) Int. Cl. A47B 19/00; F21V 33/00; F21V 23/04

(52) U.S. Cl. 362/99; 362/98; 362/276

(57) ABSTRACT

The present invention is directed to an illuminated exhibitor that assists in providing illumination for reading and viewing objects in low-light situations, such as restaurants and any other places where low light conditions make it difficult to read printed matter without additional lighting. The exhibitor includes a front cover pivotally connected to a back cover as well as a light source and battery. The exhibitor may include a light sensor to adjust the intensity of the light source. The exhibitor may include one or more panels that illuminate and can be used to display logos and the like.

### FIELD OF THE INVENTION

This invention relates to a lighted presentation device, and more particularly relates to a device that utilizes internal lighting to present articles, such as restaurant invoices and credit card bills.

### BACKGROUND OF THE INVENTION

The problems associated with low-lighting conditions in restaurants and other places are well-known. One of the most significant problems is the difficulty patrons have in reading the bill and associated credit card invoice upon completing a meal in a restaurant. Typically, the restaurant's bill is presented to the patron in a folder made of leather or vinyl over reinforced cardboard. Such folders are widely used, and may employ a first pouch for holding a credit card partially extended from the top of the folder and a second pouch or flap adapted to retain the restaurant bill and/or credit card receipt prior to signing by the patron. These folders also typically include a logo of the establishment and/or a bank or credit card company logo on the front cover and/or on an inner surface of the folder. When the patron attempts to read the bill or invoice, especially a patron with deteriorated eyesight, the patron experiences great difficulty, often searching for an alternative light source which is usually not to be found.

Some attempts have been made to address this problem. For example, U.S. Pat. No. 5,639,156 to Broxson discloses an illuminated reading device comprised of a foldable book-like device in which illumination means is energized upon one of the cover portions being opened to a pre-selected degree of tilt. The Broxson device does not directly illuminate the printed material to be read or illuminate it from behind, and requires a complicated tilt-sensitive switching assembly which uses mercury.

U.S. Pat. No. 6,808,208 to Ward discloses a restaurant check holder in which a slidable magnifying member and light-emitting assembly are removably attached to an inner facing surface of the holder. Ward suffers from the disadvantage that the slidable magnifying member requires a specific edge structure and magnifier, and does not back light the document upon which the printed matter to be read is printed upon. Additionally, the light member of Ward is located in a position where it provides the greatest amount of illumination when the two cover sections are moved toward each other. Therefore, users who require significant illumination to read printed matter will have to substantially close the booklet in order to use the device, which is both counterproductive and counter intuitive.

US Patent Application Publication No. US 2004/0059689 to Masden discloses a check presentation system which includes a folder having a credit card pocket and a bill/credit card receipt pocket on one side and a tip calculator on the other. A light is provided for downwardly directing light from an illumination source onto the key pad of the tip calculator. Not only does the light source of Masden not back light the document upon which the printed matter has been placed, but the light source, being positioned opposite the printed bill/credit card receipt pocket, requires the folder to be nearly folded in half for the light source to illuminate the printed matter.

U.S. Pat. No. 6,409,357 to Thompson discloses an illuminated billfold which directs light from an illumination source off of a reflector downwardly toward, and in a direction parallel to, a sheet of printed matter such as a restaurant bill or credit card invoice. Again, this device does not back light the document upon which the printed matter appears, and, given that the direction of incident light from the light source is parallel to the surface upon which the printed matter is printed, only a small amount of illumination results.

U.S. Pat. Nos. 6,850,767 and 5,813,748 to Maxymych discloses a transaction tray comprised of a folder having an illuminated window or windows on one side and a recessed tray having a light source disposed about the tray's periphery on the other side. Once again, no back lighting of the document containing the printed matter is accomplished.

Therefore, there is still a need for a highly functional illuminated exhibitor that provides sufficient lighting by way of a backlit panel to allow one to read printed matter in a low light environment using the widely accepted, standard, invoice and credit card receipt presentation folder in use today with minor modifications.

### SUMMARY OF THE INVENTION

The present invention encompasses an illuminated exhibitor that preferably includes adjustable lighting that provides superior illumination of printed matter in low-light environments. The present invention also employs any one of a variety of recharging systems for the power source.

### BRIEF DESCRIPTION OF THE DRAWINGS

FIG. 1 is a perspective view of an illuminated exhibitor in accordance with one embodiment of the present invention.

FIG. 2 is a view of the outside of one embodiment of the illuminated exhibitor of the present invention in the fully open position.

FIG. 3A is a front elevational view of the inside of one embodiment of the illuminated exhibitor of the present invention in the fully open position.

FIG. 3B is a cross-sectional bottom plan view of the illuminated exhibitor of the present invention taken along lines 3B-3B of FIG. 3A.

FIG. 4A is a front elevational view of the inside of a second embodiment of the illuminated exhibitor of the present invention in the fully open position.

FIG. 4B is a cross-sectional bottom plan view of the section taken along lines 4B-4B of FIG. 4A.

FIG. 5A is a schematic representation of a first embodiment of the battery charging elements of the illuminated exhibitor of the present invention.

FIG. 5B is a schematic representation of the operating circuit common to all embodiments of the illuminated exhibitor of the present invention.

FIG. 6A is a schematic representation of a second embodiment of the battery charging elements of the illuminated exhibitor of the present invention.

FIG. 6B is across-sectional bottom plan view taken along lines 6B-6B of FIG. 6A.

FIG. 7 is a schematic representation of a third embodiment of the battery charging elements of the illuminated exhibitor with a female charging connector.

FIG. 8 is a schematic representation of a fourth embodiment of the battery charging elements of the illuminated exhibitor of FIG. 6 including an optional switch element.

### DETAILED DESCRIPTION

Generally, the present invention is directed to an illuminated exhibitor that assists in providing illumination for reading and viewing objects in low-light environments, such as restaurants or any other environment in which low level lighting dictates a need for illumination of printed matter. The exhibitor includes a front cover pivotally connected to a back cover as well as a light source and battery. The exhibitor includes an illuminatable panel adapted to illuminate printed matter placed within the folder. The exhibitor may include a light sensor or other current varying (e.g. variably) resistive means to adjust the intensity of the light source. The exhibitor may include one or more additional panels that illuminate and can be used to display logos and the like.

For a fuller understanding of the invention, reference is had to the following description, taken in connection with the accompanying drawings, in which like reference numbers reference like parts throughout.

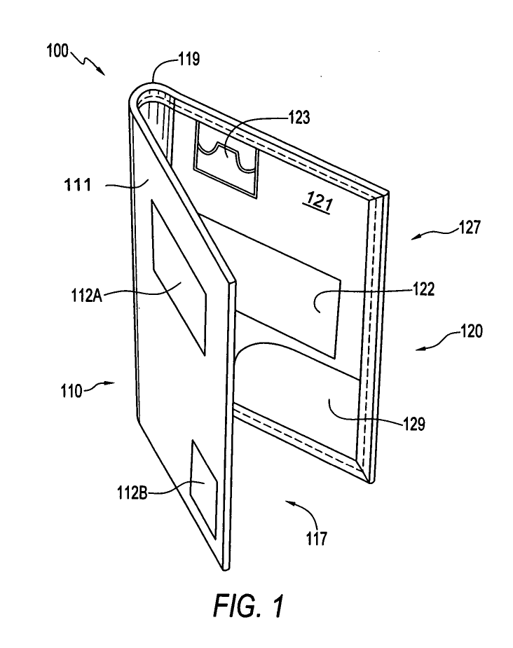

FIG. 1 provides a perspective view of one embodiment of the illuminated exhibitor 100 of the present invention. Exemplified as being incorporated within a standard restaurant bill folio in FIG. 1, the exhibitor 100 includes a front cover 110 pivotally connected to a back cover 120 by a spine or seam 119. One of ordinary skill in the art will recognize that seam 119 may be located along the sides, top or bottom of front cover 110 and back cover 120 without departing from the teachings of the present invention. Furthermore, and still within the teachings of the present invention, seam 119 could be replaced by any common structure used to pivotally connect front cover 110 to back cover 120, including, but not limited to, hinges or binders. Standard restaurant bill folios are generally comprised of a semi-rigid cardboard backing surrounded by a leather or vinyl sheet, stitched about a peripheral edge of the folio.

The front cover 110 has a front side 111 and a back side 117. As depicted in FIG. 1, the front side 111 of the front cover 110 may include a restaurant logo 112A and a credit card logo 112B. Either or both of these logos may be illuminated by the teachings of the present invention, which will be discussed in detail further along in this detailed description. In the alternative, if such an illuminated display on the front side 111 of the front cover 110 may disturb the ambience of the setting, it is possible to include the logos without illumination, or with switching structure to interrupt power to the source of illumination of the logos. If desired, the front side 111 of the front cover 110 may be provided without any logos or other indicia without departing from the scope or spirit of the invention.

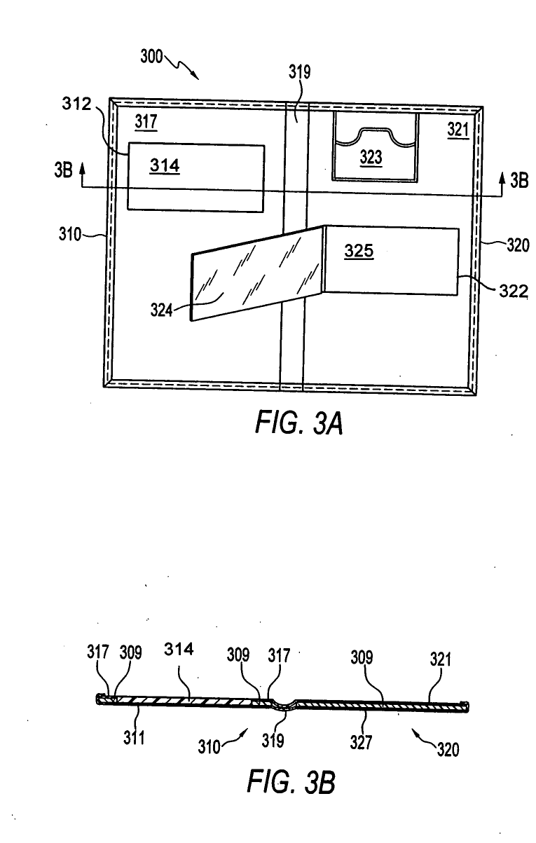

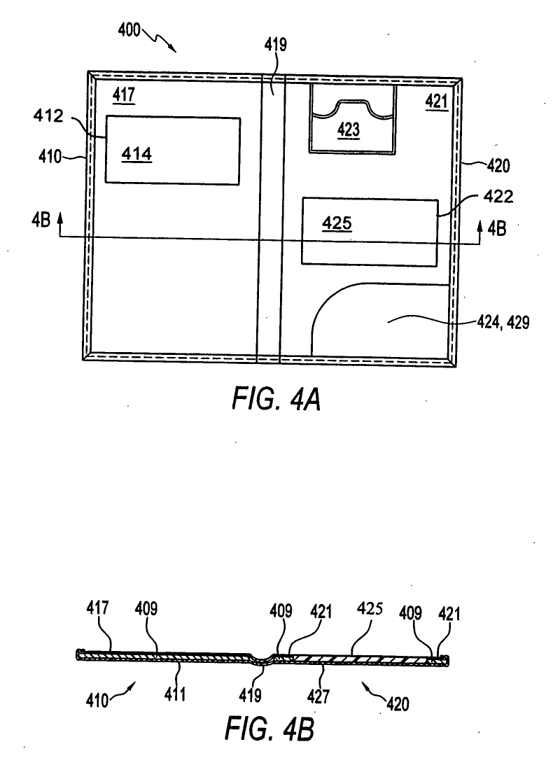

The back cover 120 also includes a front side 121 and a back side 127. As depicted in FIG. 1, the front side 121 of the back cover 120 may include a credit card pouch or holder 123, a receipt flap 129 and an illuminator such as illuminated panel 125. The details of the front side 121 of the back cover 120 are discussed in further detail in connection with FIGS. 3A and 4A.

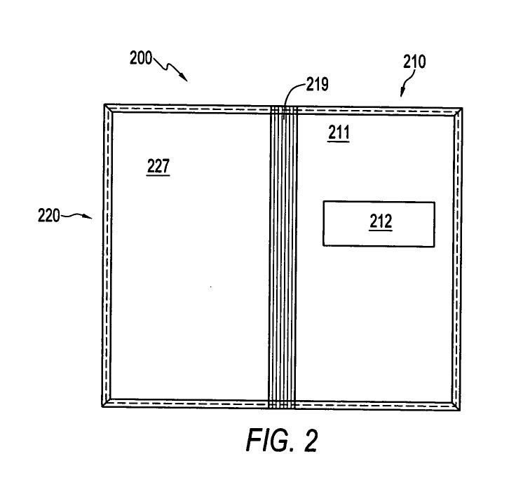

FIG. 2 is a front elevational view of the outside of a modified embodiment of the illuminated exhibitor 200 of the present invention. The back cover 220 is pivotally connected to the front cover 210 by a seam 219. In this embodiment, the front side 211 of the front cover 210 includes or defines one window 212 and the back side 227 of the back cover 220 does not include or define any windows. One of ordinary skill in the art will recognize that alternate embodiments may be accomplished utilizing the teachings of the present invention, such as, for example, one employing a window or windows (not shown) on the back side 227 of back cover 220, which could be used for advertising or other information disseminating purposes.

By “transparent” is meant capable of conducting, radiating, permitting passage of, or otherwise conveying or exhibiting visible light. For example, any of the “windows” of this invention may employ “transparent” coverings, which may be clear or translucent, or may simply be openings defined by the covering material of the exhibitor without employing any protective covering over the illuminated panel.

FIGS. 3A and 4A are front elevational views of two embodiments of the inside of the illuminated exhibitor 300, 400 of the present invention. The inside of the illuminated exhibitors 300, 400 are comprised of back sides 317, 417 of front covers 310, 410 and the front sides 321, 421 of back covers 320, 420. In this embodiment, the front covers 310, 410 are pivotally connected to the back covers 320, 420 along seams 319, 419. Similar to the embodiment provided in FIG. 1, the seams 319, 419 may take other forms and/or be alternately located or constructed and still be within the teachings of the present invention.

The embodiments of the illuminated exhibitors 300, 400 depicted in FIGS. 3A-4B include light sources, preferably illuminated panels 314, 414, 322, 422, substantially in registry or substantially aligned with two transparent windows; first transparent windows 312, 412 defined by the back sides 317, 417 of front covers 310, 410 and second transparent windows 325, 425 defined by the front sides 321, 421 of the back covers 320, 420. The present invention is not limited to these embodiments and may include only one of either of the transparent windows and associated illuminated panels. In an alternative embodiment, additional windows and associated illuminated panels may be included.

The structure, purpose and utility of the transparent windows and associated illuminated panels will be discussed further into the specification. However, it is to be understood that what is meant by “window” is an opening or aperture in the respective covers. The windows may or may not be covered by a transparent (as defined herein) sheet to cover the illumination source. One or more of the windows may be partially covered by opaque or translucent graphical material such as lettering and/or graphics which, when backlit, are permanently emphasized.

FIG. 3B is a cross-sectional bottom plan view along lines 3B-3B in FIG. 3A. As shown in FIG. 3B, the illuminated panel 314 of the front cover 310 is aligned with the window or aperture 312 in the front cover 310. In this embodiment, there is no transparent sheet or other covering over the window 312. Window 312 is simply an aperture in the front cover 310. The surface of the illuminated panel is located in substantially the same plane as the back side 317 of the front cover 310. This may result in direct contact between the illuminated panel 314 and the bill or receipt when the bill or receipt is placed upon the panel 314. As a result, the illuminated panel 314 must be designed to withstand the expected abuses to be encountered in a variety of settings, including spilled drinks, curious children, friction from numerous bills and receipts being dragged thereover, to name a few.

FIG. 4B is a cross-sectional bottom plan view along lines 4B-4B in FIG. 4A. Similar to FIG. 3B, the illuminated panel 422 is substantially co-planar with the front side 421 of back cover 420. Once again, window 425 is simply an aperture in the front side 421 of back cover 420. As discussed previously, the embodiments depicted in FIGS. 3B and 4B provide one of many ways to accomplish the windows of the present invention. In alternative embodiments, the windows may include transparent sheets or opaque sheets containing logos and insignia.

FIGS. 3B and 4B provide cross-sectional bottom plan views of two embodiments of the illuminated exhibitors 300, 400. The front covers 310, 410 and back covers 320, 420 and the components located therein are reinforced and secured by reinforcement material 309, 409 between the front sides 311, 411, 321, 421 and back sides 317, 417, 327, 427. The reinforcement material 309, 409 may include cardboard, plastic, or any other material that is thin and lightweight, but that stabilizes the covers.

The embodiments of the illuminated exhibitors 300, 400 depicted in FIGS. 3A-4B include optional pouches or pockets 323, 423 for a credit or debit card on the front sides 321, 421 of the back cover 320, 420. One of ordinary skill in the art will recognize that the location and size of the pockets 323, 423 can be varied without detracting from the scope of the present invention, such as by placing them on the back side 317, 417 of front covers 310, 410 or on the outside of the exhibitors 300, 400. The pockets 323, 423 may be made of plastic or any other suitable material.

In the embodiment shown in FIG. 3A, the illuminated exhibitor 300 includes an optional magnifier 324 (shown in a fully opened position in FIG. 3A). Inclusion of this magnifier 324 allows the consumer to view an enlarged image of the text of the bill or receipt for easier reading. The magnifier 324 can be attached to the front side 321 of the back cover 320 by any conventional means including, but not limited to, tape, glue, ultrasonic welding, a mechanical hinge or the like. One of ordinary skill in the art will recognize that the magnifier 324 can be located anywhere on the interior of the illuminated exhibitor 300 to perform the function of magnifying the print on a bill or receipt. The magnifier may take any form or shape, so long as it can be used to enlarge the size of print on a bill or receipt. When moved to the closed position (not shown), magnifier 324 will sandwich a bill or receipt between itself and the illuminated panel 322.

In an alternate embodiment, the magnifier 324 may be arranged so that, when it is placed in a closed position on top of the window 322 and supported thereabove, it will define a space in which a bill or receipt may be placed. In a third alternative embodiment, the magnifier 324 may be attached in a stationary manner to the front side 321 of the back cover 320 and be spaced from window 322 so that a bill or receipt may be placed therebetwixt.

FIG. 4 includes another alternate embodiment of the magnifier 424. The magnifier 424 performs the same function as that of FIG. 3, but is attached in a stationary manner to the front side 421 of the back cover 420. In this embodiment, the magnifier 424 also serves to act as a receipt holder 429. One of ordinary skill in the art would recognize that the location of the magnifier 324, 424 is irrelevant, as long as there is a light source behind it.

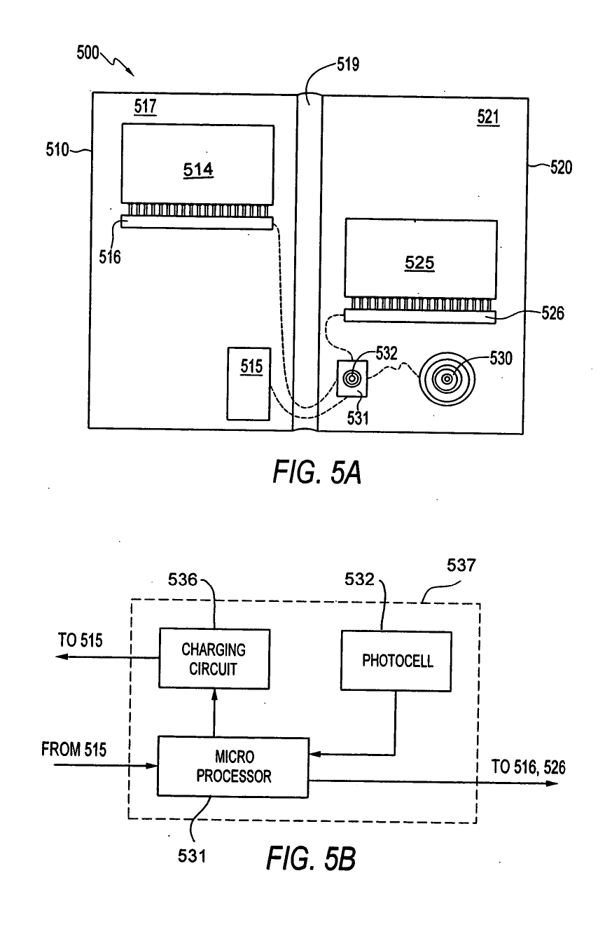

FIGS. 5A through 8 provide internal views (i.e. with covers 517, 521, 617, 621, 717, 721, 817, and 821 removed to expose the interior of the exhibitors) of four embodiments of the illuminated exhibitors 500, 600, 700, 800 of the present invention. All of the embodiments in FIGS. 5A through 8 include illumination panels 514, 614, 714, 814 associated with the back side 517, 617, 717, 817 of the front cover 510, 610, 710, 810 and illumination panels 525, 625, 725, 825 associated with the front side 521, 621, 721, 821 of the back cover 520, 620, 720, 820. The illumination panels 514, 525, 614, 625, 714, 725, 814, 825 are placed generally substantially in registry or substantially aligned with the windows 312, 322, 412, 422 provided in the embodiments depicted in. FIGS. 3 and 4. Details of the illumination panels 514, 525, 614, 625, 714, 725, 814, 825 will be provided below. The windows 312, 322, 412, 422, if they include a transparent sheet, are located on top of, and illuminated by, the illumination panels 514, 525, 614, 625, 714, 725, 814, 825. The windows 312, 322, 412, 422 may be simply that, transparent windows, or may include logos or advertising of the owner of the illuminated exhibitor 300, 400. In an alternate embodiment, no transparent sheet is used to cover the windows, such that the illuminated panels 514, 525, 614, 625, 714, 725, 814, 825 are joined or placed substantially in registry with windows 312, 322, 412, 422. Once again, these embodiments are provided for exemplary purposes only and are not intended to limit the scope of the appended claims.

The embodiments of the invention provided in FIGS. 5A through 8 include internal batteries 515, 615, 715, 815, two illumination panels 514, 525, 614, 625, 714, 725, 814, 825, two light sources 516, 526, 616, 626, 716, 726, 816, 826, a recharging mechanism 530, 630, 730, 830, and optionally, a microprocessor 531, 631, 731, 831 and optionally, a photo cell 532, 632, 732, 832. It is to be understood, however, that all that is needed to practice the principles of this invention is to provide a single illumination source, such as illumination panels 525, 625, 725, and 825 to back light the bill or receipt or other printed material.

Preferably, the internal batteries 515, 615, 715, 815 are sufficiently flat so as to fit within the illuminated exhibitors 500, 600, 700, 800 without appearing bulky and detracting from the general overall appearance. Some suitable examples of internal batteries include lithium-ion, nickel-cadmium and nickel metal hydride. At the present time, the lithium-ion battery is preferred because it is readily available, inexpensive, lightweight, has a high power density and does not exhibit a memory effect. In addition, the lithium-ion battery operates at 3.6 volts, which is the voltage required by one embodiment of the illuminated panels of the present invention. Therefore, there is no need for the addition of a limiting resistor to adjust the batteries' voltage. However, one of ordinary skill in the art will recognize that battery technology is forever evolving and other batteries, both currently existing and future developed, may function equally well in the teachings of the present invention.

The light source of the present invention may be in this form of one or more of illumination panels 514, 525, 614, 625, 714, 725, 814, 825 and light strips 516, 526, 616, 626, 716, 726, 816, 826. One embodiment of the present invention combines the illumination panels 514, 525, 614, 625, 714, 725, 814, 825 and light strips 516, 526, 616, 626, 716, 726, 816, 826 into one component, a backlighter. A suitable backlighter for use with the present invention is produced by Marktech Optoelectronics of Latham, N.Y. The backlighter is available in a variety of sizes and colors and includes a durable acrylic panel (thereby removing the need to include a transparent sheet over the windows). The backlighter typically lasts 100,000 hours and utilizes less power than standard incandescent, electroluminescent (EL), or cold cathode fluorescent lamp (CCFL) light sources. One preferred backlighter (Marktech Part No. MTBL2129-G) provides 574 nm of light at an intensity of 220.00 millicandelas.

The four embodiments also include an optional microprocessor 531, 631, 731, 831. The microprocessor 531, 631, 731, 831 can be designed to control the charging system 530, 630, 730, 830, the illumination strips 516, 526, 616, 626, 716, 726, 816, 826, and, optionally, a photocell 532, 632, 732, 832. The microprocessor can be designed using standard “chip on board” (“COB”) technology. A basic COB microprocessor 531, 631, 731, 831 suitable for use in the invention closes (i.e. enables) the circuit and thereby illuminates the illumination panels 514, 525, 614, 625, 714, 725, 814, 825 when the illuminated exhibitor 500, 600, 700, 800 is opened and opens (i.e. disables) the circuit when the illuminated exhibitor is closed, rendering the illumination panels 514, 525, 614, 625, 714, 725, 814, 825 dark. In an alternate embodiment, the COB microprocessor 531, 631, 731, 831 might be connected to a photo cell 532, 632, 732, 832 and thereby adjust the intensity of the illumination panels 514, 525, 614, 625, 714, 725, 814, 825 based on the distance between the front cover 510, 610, 710, 810 and back cover 520, 620, 720, 820. One of ordinary skill in the art will recognize that additional microprocessor embodiments could also be designed without departing from the teachings of the present invention, such as automatic closure of the circuit (darkness) after 10 minutes of non-use or the like.

FIG. 5B shows a representative circuit 537 schematic that will work to accomplish the functions microprocessor 531 of the invention. Power from battery 515 drives microprocessor 531. A charging circuit 536 is connected between battery 515 and microprocessor 537 to accomplish the battery charging function of the invention, to be described in more detail below. A variable impedance device such as a photocell 532, a rheostat (not shown) or the like may be used to vary the current flowing to light strips 516, 526 in proportion to ambient lighting conditions, the position of the rheostat (not shown) or the like. In other words, in the case of a photocell 532, if the ambient light is bright, the power to light strips 516, 526 can be reduced or eliminated entirely by the photocell 532 causing the microprocessor 531 to reduce its power output so as to extinguish or dim the associated illumination panels 514, 525 to reduce battery 515 depletion.

One of ordinary skill in the art will also recognize that inclusion of a microprocessor 531, 631, 731, 831 is not required to practice the teachings of the present invention. The electrical connection between the battery 515, 615, 715, 815 and illumination panels 514, 525, 614, 625, 714, 725, 814, 825 could be designed to provide a closed (i.e. enabled) circuit when the illuminated exhibitor 500, 600, 700, 800 is open and an open (i.e. disabled) circuit when it is closed. For example, the connection between the battery 515, 615, 715, 815 and one illumination panel, preferably an illumination panel located on the opposite cover from the battery 515, 615, 715, 815, could be disconnected by a switch associated with the seam 519, 619, 719, 819 when the illuminated exhibitor 500, 600, 700, 800 is closed, thereby opening the circuit and rendering the exhibitor 500, 600, 700, 800 dark. When the exhibitor 500, 600, 700, 800 is opened, the electrical connection between the battery 515, 615, 715, 815 and the illumination panel could be rejoined, thereby lighting the illuminated exhibitor 500, 600, 700, 800.

Finally, there may be users who desire to have the illuminated exhibitor 500, 600, 700, 800 illuminated when closed as opposed to opened, for any variety of reasons, such as to illuminate one or more panels associated with one or more information conveying articles (e.g. logos) on front panel. If so desired, this may be accomplished by reversing the circuit described above as to such panels.

To help reduce waste and lengthen battery life, the illuminated exhibitor of the present invention contemplates a variety of alternatives recharging mechanisms. Suitable recharging mechanisms include solar, magnetic and electric systems. In FIG. 5A, this recharging mechanism 530 is an inductive coupler which employs a near field charge coil 530 and a corresponding charging base (not shown) which generates an inductive field into which one or more of exhibitors 500 are to be placed. One such charging system is sold under the trademark “Splash Pad” by Splashpower Ltd., of Cambridge, U.K. When the battery 515 needs recharging, the illuminated exhibitor 500 is placed in the charging base (not shown). The charging base generates an inductive field that charges the power receiver. The benefit of this embodiment is that one or more illuminated exhibitors 500 can be placed in the charging base (not shown) whenever staff has finished using them. As the technology is wireless, there is no need to “plug in” the illuminated exhibitor 500. This embodiment reduces the need for owners to monitor staff for compliance with re-charging because a visual survey of the exhibitors lying in the charging base provides the needed assurances that re-charging is occurring.

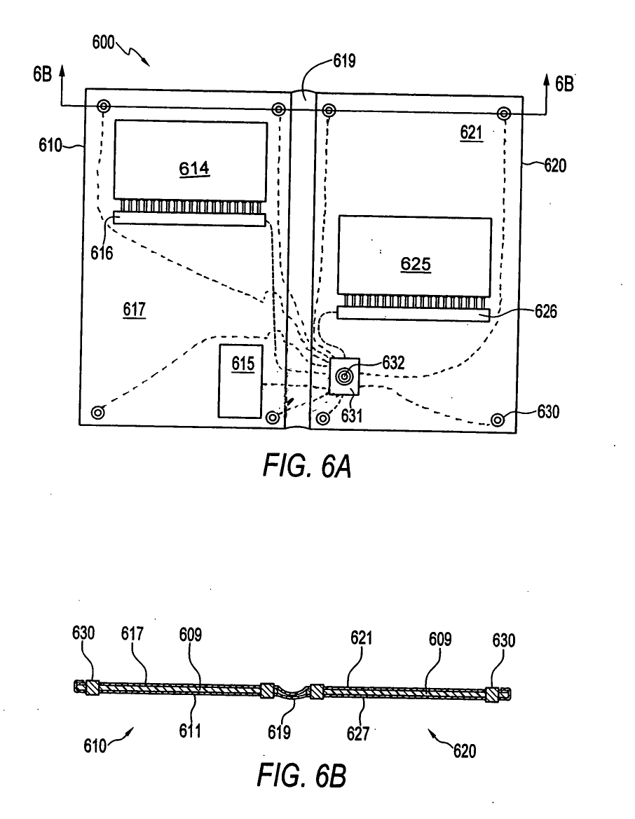

FIG. 6A shows an alternate embodiment of the recharging mechanism of the illuminated exhibitor 600 of the present invention. In this embodiment, charging pins 630 are connected to the microprocessor 631 to facilitate recharging the battery 615. These connections may be made by a piece of wire, flexible circuit or direct contact with charging pins 630 of adjacent exhibitors (not shown). As depicted in FIGS. 6A and 6B, the charging contacts 630 are located in each corner of the front cover 610 and back cover 620. The charging contacts extend from the back side 617 to the front side 611 of the front cover and from the front side 621 to the back side 627 of the back cover 620. With this design, the illuminated exhibitors 600 can be stacked on top of each other for recharging. A charging base (not shown) is provided in which the first illuminated exhibitor 600 is placed. The charging base (not shown) contains charging contacts that mate with the charging pins of the illuminated exhibitor 600. Additional illuminated exhibitors can then be stacked on top of the first when charging is required to achieve electrical continuity between all stacked exhibitors. At the end of an event or at the close of business, the manager can view the charging base and illuminated exhibitors stacked therein to determine that the staff has complied with any recharging requirements.

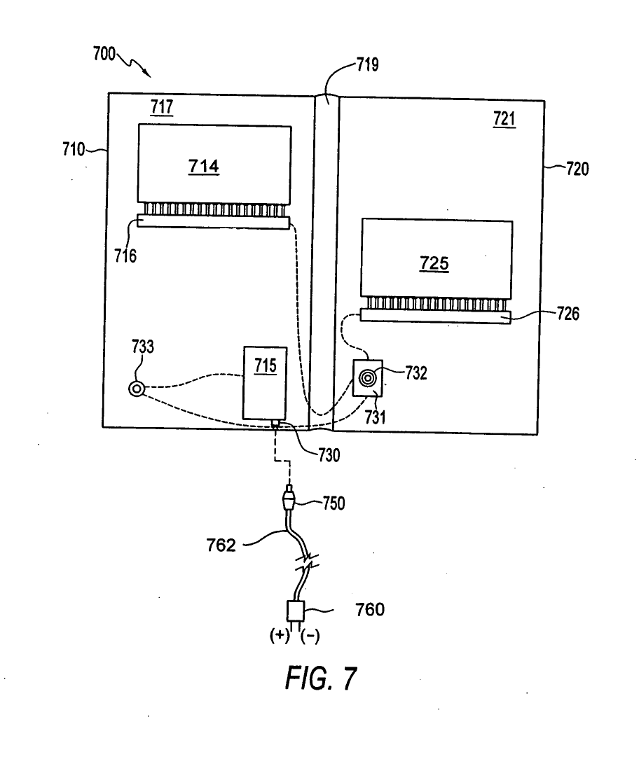

As shown in FIG. 7, the present invention may also utilize a conventional plug-in charging connector to facilitate charging. The illuminated exhibitor 700 may include a female electrical connector 730 and be used with a typical corresponding male electric connector 750. Re-charging would occur by plugging transformers 760 into an electric source, such as a standard household outlet or car cigarette lighter adapter. Electrical lead 762 between male electrical connector 750 and transformer 760 may be split into any number of parallel leads such that charging of multiple batteries 715 can be accomplished at the same time. One skilled in the art will readily appreciate that the transformer 760 may be varied in its characteristics to accommodate the charging of multiple batteries simultaneously.

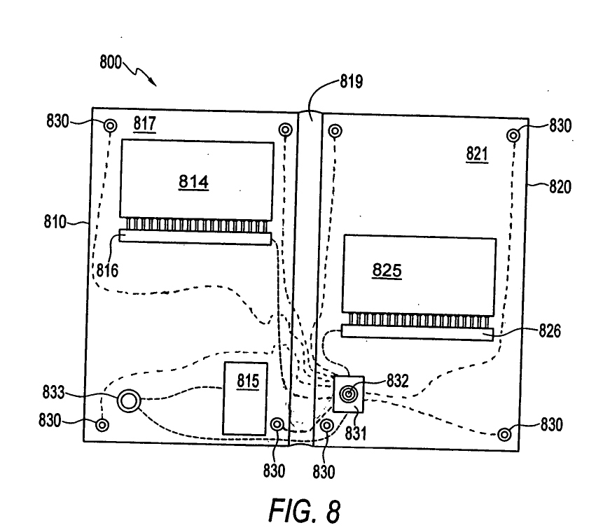

The embodiment depicted in FIGS. 7 and 8 employs an additional element to the internal components of the illuminated exhibitor 700, 800 in the form of an on/off switch 733, 833. Inclusion of such is useful when the charging pin method is used or if the exhibitor is used in both day and night time conditions. For example, a restaurant may have outside seating and not require the exhibitor to be illuminated by day, but may need it by night. In that case, the battery charge can be saved during daylight hours by turning off the exhibitor. When dusk falls, the switch 733, 833 can be turned on to provide the necessary illumination.

The invention has been shown and described herein in the form of preferred embodiments with alternative features. It is to be understood, however, that the invention is not limited to the embodiments and additional features disclosed herein, and that the invention is intended to be limited only by the following claims.

### REFERENCE NUMBERS

| | | | | | | | | |
|---|---|---|---|---|---|---|---|---|
| 100 | Illuminated Exhibitor | 200 | 300 | 400 | 500 | 600 | 700 | 800 |
| | Reinforcement material | | 309 | 409 | | 609 | | |
| 110 | Front Cover | 210 | 310 | 410 | 510 | 610 | 710 | 810 |
| 111 | Front Side | 211 | 311 | 411 | | 611 | | |
| | Window | 212 | 312 | 412 | | | | |
| 112A | Restaurant logo | | | | | | | |
| 112B | Credit card logo | | | | | | | |
| | Magnifier | | | | | | | |
| | Illuminated Panel | | 314 | 414 | 514 | 614 | 714 | 814 |
| | Battery | | | | 515 | 615 | 715 | 815 |
| | Light Source | | | | 516 | 616 | 716 | 816 |
| 117 | Back Side Transparent window | | 317 | 417 | 517 | 617 | 717 | 817 |
| 119 | Seam | 219 | 319 | 419 | 519 | 619 | 719 | 819 |
| 120 | Back Cover | 220 | 320 | 420 | 520 | 620 | 720 | 820 |
| 121 | Front Side | | 321 | 421 | 521 | 621 | 721 | 821 |
| 122 | Window | | 322 | 422 | | | | |
| 123 | Credit card pouch/holder | | 323 | 423 | | | | |
| | Magnifying Glass | | 324 | 424 | | | | |
| | Illuminated panel | | 325 | 425 | 525 | 625 | 725 | 825 |
| | Light Source | | | | 526 | 626 | 726 | 826 |
| 127 | Back Side | 227 | 327 | 427 | | 627 | | |
| 129 | Receipt flap | | | 429 | | | | |
| | Recharge Mechanism | | | | 530 | 630 | 730 | 830 |
| | Microprocessor | | | | 531 | 631 | 731 | 831 |
| | Photocell | | | | 532 | 632 | 732 | 832 |
| | On/Off Switch | | | | | | 733 | 833 |
| | Charging Circuit | | | | 536 | | | |
| | Microprocessor Circuit | | | | 537 | | | |
| | Male electric connector | | | | | | 750 | |
| | Transformer | | | | | | 760 | |
| | Electrical lead | | | | | | 762 | |

We claim:

1. An illuminated exhibitor comprising:
a front cover having a front side and a back side;
a back cover having a front side and a back side and pivotally connected to the front cover;
a battery and light source associated with the front cover, the back cover, or both;
the light source being positioned in such a manner so as to illuminate a portion of the front cover, the back cover, or both, to assist users in viewing and reading printed matter positioned on top of the front side of the back cover, the back side of the front cover, or both.

2. The illuminated exhibitor of claim 1 further comprising a light sensor, wherein the light sensor causes an intensity of the light source to be adjusted.

3. The illuminated exhibitor of claim 1 further comprising a magnifier attached to the back side of the front cover.

4. The illuminated exhibitor of claim 1 further comprising a magnifier attached to the front side of the back cover.

5. The illuminated exhibitor of claim 2, further comprising a first transparent window substantially coplanar with the back side of the front cover.

6. The illuminated exhibitor of claim 5, further comprising a second transparent window substantially coplanar with the front side of the front cover.

7. The illuminated exhibitor of claim 5, further comprising a second transparent window substantially coplanar with the front side of the back cover.

8. The illuminated exhibitor of claim 6, further comprising a third transparent window substantially coplanar with the front side of the back cover.

9. The illuminated exhibitor of claim 7, further comprising a third transparent window substantially coplanar with the back side of the back cover.

10. The illuminated exhibitor of claim 8, further comprising a fourth transparent window substantially coplanar with the back side of the back cover.

11. The illuminated exhibitor of claim 8 further comprising a magnifier attached to the back side of the front cover.

12. The illuminated exhibitor of claim 11 wherein the magnifier is hingeably connected to the third transparent window.

13. The illuminated exhibitor of claim 2, further comprising a first transparent window substantially coplanar with the front side of the back cover.

14. The illuminated exhibitor of claim 13, further comprising a second transparent window substantially coplanar with the back side of the back cover.

15. The illuminated exhibitor of claim 13, further comprising a second transparent window substantially coplanar with the back side of the front cover.

16. The illuminated exhibitor of claim 15, further comprising a third transparent window substantially coplanar with the front side of the front cover.

17. The illuminated exhibitor of claim 16, further comprising a fourth transparent window substantially coplanar with the back side of the back cover.

18. The illuminated exhibitor of claim 13 further comprising a magnifier attached to the back side of the front cover.

19. The illuminated exhibitor of claim 18 wherein the magnifier is hingeably connected to the first transparent window.

20. An illuminated exhibitor comprising:
a front cover having a front side and a back side;
a back cover having a front side and a back side and pivotally connected to the front cover;
a microprocessor, battery and light source associated with the front cover, the back cover, or both;
the light source being positioned in such a manner so as to illuminate the panel and a portion of the front cover, the back cover, or both, to assist users in viewing and reading printed matter positioned on top of the front side of the back cover, the back side of the front cover, or both.

21. The illuminated exhibitor of claim 20 further comprising a light sensor, wherein the light sensor causes an intensity of the light source to be adjusted.

22. The illuminated exhibitor of claim 20 further comprising a magnifier attached to the back side of the front cover.

23. The illuminated exhibitor of claim 20 further comprising a magnifier attached to the front side of the back cover.

24. The illuminated exhibitor of claim 20 further comprising additional panels on the front side of the front cover, the back side of the back cover, or both.
